(19) United States
(12) Patent Application Publication
(10) Pub. No.: US 2018/0303230 A1
(43) Pub. Date: Oct. 25, 2018

(54) CLIP ASSEMBLY

(71) Applicant: Wayne Haas, Bradenton, FL (US)

(72) Inventor: Wayne Haas, Bradenton, FL (US)

(21) Appl. No.: 15/491,446

(22) Filed: Apr. 19, 2017

(51) Int. Cl. A45F 5/02; A45F 5/06; F16B 2/22

(52) U.S. Cl. CPC A45F 5/021; F16B 2/22; A45F 5/06

(57) ABSTRACT

A clip assembly has a first retaining member removably securable to a wearable article. The first retaining member has a top part, and first and second ends tensioned towards each other, the top part and ends defining a downward facing opening for removably securing the clip assembly to the wearable article. A second retaining member is coupled to the first retaining member for removably retaining a first item while not in use. The second retaining member includes a base and at least one arm extending upwardly therefrom, the base and arm defining a first upward facing opening for receiving the first item. A third retaining member removably retains a second item while not in use. The third retaining member, coupled to the second retaining member, has proximal and distal portions with respect to the second retaining member which define a second upward facing opening for receiving the second item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to clips and more particularly pertains to a new clip assembly for holding and carrying items.

### BRIEF SUMMARY OF THE INVENTION

An embodiment of the disclosure meets the needs presented above by generally comprising a clip assembly having a first retaining member removably securable to a wearable article. The first retaining member has a top part, and first and second ends tensioned towards each other, the top part and ends defining a downward facing opening for removably securing the clip assembly to the wearable article. A second retaining member is coupled to the first retaining member for removably retaining a first item while not in use. The second retaining member includes a base and at least one arm extending upwardly therefrom, the base and arm defining a first upward facing opening for receiving the first item. A third retaining member removably retains a second item while not in use. The third retaining member, coupled to the second retaining member, has proximal and distal portions with respect to the second retaining member which define a second upward facing opening for receiving the second item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a clip assembly according to an embodiment of the disclosure.

FIG. 2 is a back view of an embodiment of the disclosure.

FIG. 3 is a side view of an embodiment of the disclosure.

FIG. 4 is a front view of an embodiment of the disclosure.

FIG. 5 is a view of an embodiment of the disclosure in use.

FIG. 6 is a view of an embodiment of the disclosure in use.

### DETAILED DESCRIPTION OF THE INVENTION

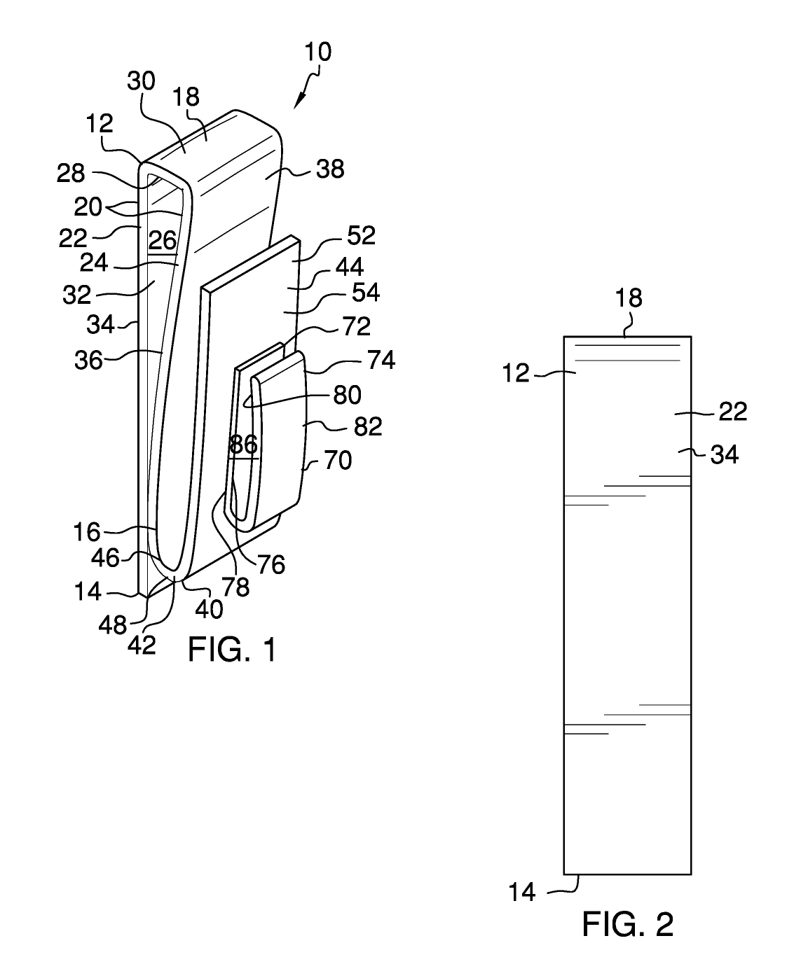

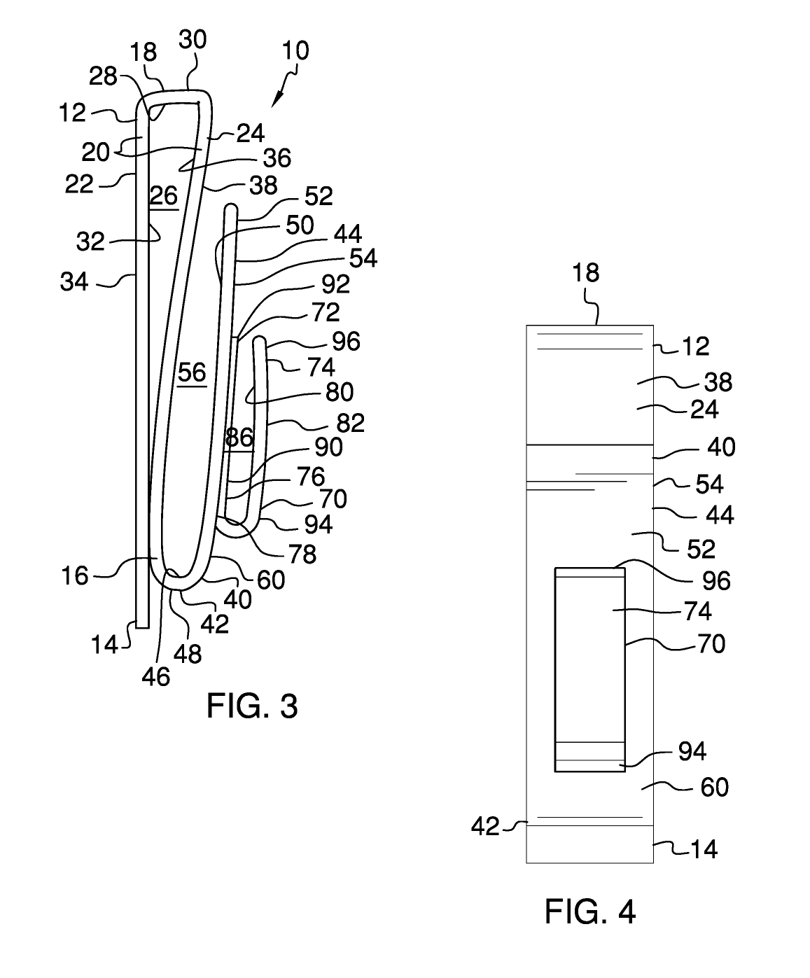

With reference now to the drawings, and in particular to FIGS. 1 through 6 thereof, a new clip assembly embodying the principles and concepts of an embodiment of the disclosure and generally designated by the reference numeral 10 will be described.

As best illustrated in FIGS. 1 through 6, the clip assembly 10 generally comprises a first retaining member 12, a second retaining member 40 and a third retaining member 70.

The first retaining member 12 has a first end 14 and a second end 16, the first end 14 and second end 16 being tensioned towards each other. The top part 18, the first end 14 and the second end 16 together define a downward facing opening 26 by which the first retaining member 12 is configured for removable securement of the clip assembly 10 to a wearable article. The first retaining member 12 has a top part 18 and a pair of legs 20 extending downwardly therefrom, the pair of legs 20 comprising a first leg 22 and a second leg 24, the top part 18 and the pair of legs 20 further defining the downward facing opening 26. The top part 18 has an interior region 28 and an exterior region 30. The first leg 22 has an interior region 32 and an exterior region 34. The second leg 24 has an interior region 36 and an exterior region 38.

In one embodiment, the top part 18 has a length of between 0.25 inch and 0.75 inch, the top part 18, the first leg 22 and the second leg 24 each have a width between 0.50 inch and 1.50 inches, and the first leg 22 and the second leg 24 each have a height between 2.50 inches and 4.00 inches.

A second retaining member 40 coupled to the first retaining member 12 is configured for removably retaining and carrying a first item while the first item is not in use. The second retaining member 40 comprises a base 42 and at least one arm 44 extending upwardly from the base 42. The base 42 has an interior area 46 and an exterior area 48. The at least one arm 44 has an interior area 50 and an exterior area 52. The interior area 46 of the base 42 and the interior area 50 of the at least one arm 44 define a first upward facing opening 56 configured to removably receive and carry the first item. The exterior area 48 of the base 42 and the exterior area 52 of the at least one arm 44 define an exterior area 60 of the second retaining member 40.

In one embodiment, the base 42 and the at least one arm 44 each have a width of between 0.50 inch and 1.50 inches, the base 42 has a length of between 0.25 inch and 0.75 inch, and the at least one arm 44 has a height of between 2.00 inches and 3.50 inches.

In one embodiment, the second retaining member 40 is integral with the first retaining member 12 such that the at least one arm 44 comprises a single arm 54 and said first upward facing opening 56 is further defined by the exterior region 38 of the second leg 24 of the first retaining member 12.

In an alternative embodiment according to the disclosure, the second retaining member 40 may be provided as a separate member that is not integral with the first retaining member 12, but is attached to the first retaining member 12. In a non-limiting example of such an alternative embodiment according to the disclosure, the at least one arm of the second retaining member may comprise a first arm and a second arm, each of the first and second arms extending upwardly from the base, the second retaining member being attached to the first retaining member by attachment of the second arm to the exterior region of the second leg of the first retaining member. Further, the base, the first leg and the second leg may each have interior areas which together define the upward facing opening of the second retaining member in which a portion of the first item would be held.

A third retaining member 70 coupled to the second retaining member 40 is configured for retaining and carrying a second item while the second item is not in use.

The third retaining member 70 further comprises a proximal portion 72 and a distal portion 74 with respect to the second retaining member 40. The proximal portion 72 has an interior proximal surface 76 and an exterior proximal surface 78, and the distal portion 74 has an interior distal surface 80 and an exterior distal surface 82, the exterior proximal surface 78 of the proximal portion 72 being attached to the second retaining member 40 at the exterior area 52 of the at least one arm 44 of the second retaining member 40. The interior proximal surface 76 of the proximal portion 72 and the interior distal surface 80 of the distal portion 74 define a second upward facing opening 86 of the third retaining member 70 configured to removably receive and carry the second item. The proximal portion 72 has a lower proximal portion 90 and an upper proximal portion 92 and the distal portion 74 has a lower distal portion 94 and an upper distal portion 96. The lower distal portion 94 is curved outwardly from the lower proximal portion 90 and the upper distal portion 96 is curved inwardly towards the upper proximal portion 92 such that the distal portion 74 is tensioned towards the proximal portion 72.

In one embodiment of the disclosure, the third retaining member 70 has a width of between 0.25 inch and 0.75 inch, and a height of between 0.75 inch and 1.5 inches.

In one embodiment of the disclosure the first, second and third retaining members are made of a resiliently flexible material. Non-limiting examples of the resiliently flexible material include plastic, silicone rubber, and metal.

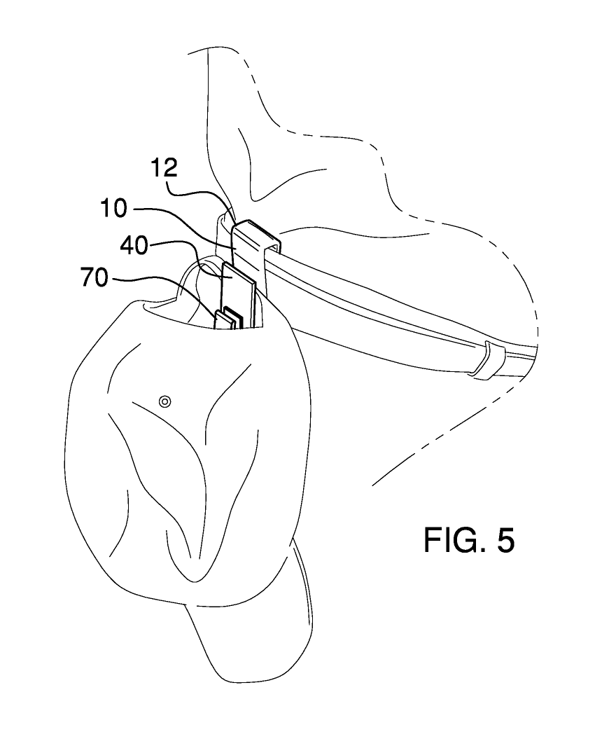

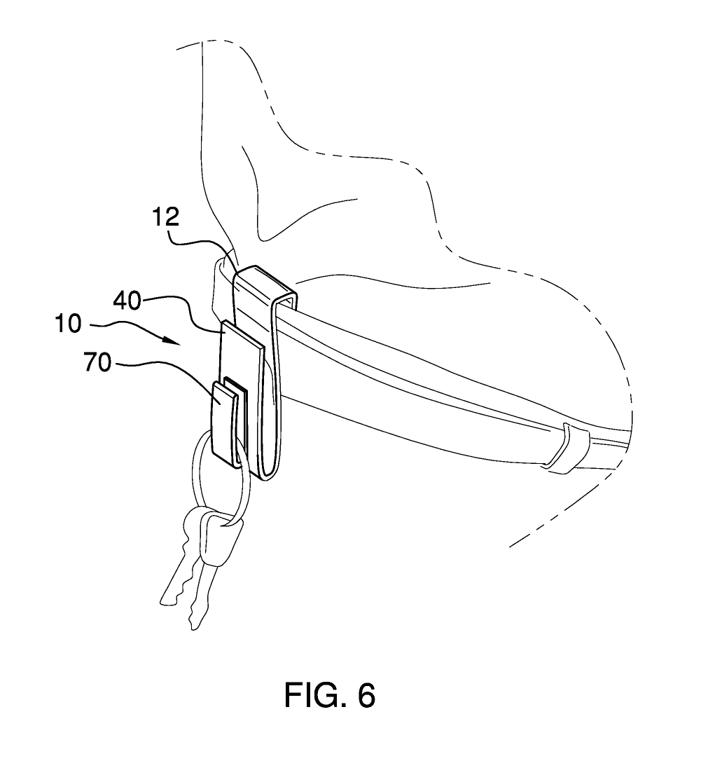

The clip assembly according to the disclosure may be used with any wearable articles, non-limiting examples of which include a pair of pants, a pair of shorts, a skirt, a belt, a purse, a backpack, a jacket, and a garment having a pocket. Referring to FIGS. 5 and 6, the clip assembly is shown attached to a waist band of a garment. In FIG. 5, the second retaining member is shown holding a cap. Non-limiting examples of the first item which may be retained in the second retaining member of the clip assembly may include a hat, a towel, a scarf, a pair of gloves, a garment, tools, and any item of sporting goods. In FIG. 6, the third retaining member is shown holding a key ring. Non-limiting examples of the second item which may be retained in the third retaining member of the clip assembly may include a key holder, a towel, an article of jewelry, a small tool, and any item capable of being carried on a tether that is removably attachable to the third retaining member.

The clip assembly according to the disclosure has many advantages. The clip assembly may be used by anyone needing to retain an item not in use to provide convenient access to the item when needed and prevent misplacement or loss of the item, including but not limited to workers, travelers, shoppers, golfers, bartenders, wait staff, and cleaning staff. The clip assembly may be used at home, when working in the home, garage or yard. The clip assembly may also be used away from home, when working, traveling, shopping, or when at a restaurant, on a golf course, or at a sporting event.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A clip assembly comprising:
a first retaining member configured for removable securement to a wearable article and having a top part, a first end and a second end, said ends being tensioned towards each other, said top part and said ends defining a downward facing opening configured for removable securement to the wearable article;
a second retaining member coupled to said first retaining member configured for removably retaining a first item while not in use, said second retaining member comprising a base and at least one arm extending upwardly therefrom, said base and said at least one arm defining a first upward facing opening configured to removably receive the first item;
a third retaining member coupled to said second retaining member configured for retaining a second item while not in use, said third retaining member further comprising a proximal portion and a distal portion with respect to said second retaining member, said proximal and distal portions defining a second upward facing opening configured to removably receive the second item.

2. The clip assembly of claim 1, wherein:
said first retaining member further comprises a pair of legs extending downwardly from the top part, said top part and said pair of legs further defining said downward facing opening;
said base and said at least one arm of said second retaining member each have an interior area and an exterior area, said interior area of said base and said interior area of said at least one arm further defining said first upward facing opening of said second retaining member; and
said proximal portion and said distal portion of said third retaining member each have an interior surface and an exterior surface, said exterior surface of said proximal portion being attached to said second retaining member at said exterior surface of said at least one arm thereof, said interior surface of said proximal portion and said interior surface of said distal portion of said third retaining member further defining said second upward facing opening of said third retaining member.

3. The clip assembly of claim 2, wherein:
said pair of legs of said first retaining member further comprise a first leg and a second leg;
said top part, said first leg and said second leg of said first retaining member each have an exterior region and an interior region; and
said downward facing opening of said first retaining member is further defined by said interior region of said first leg, said interior region of said second leg and said interior region of said top part.

4. The clip assembly of claim 3, wherein:
said first leg and said second leg of said first retaining member each have a width being between 0.50 inch and 1.50 inches, said top part having a length being between 0.25 inch and 0.75 inch, and said first leg and said second leg each having a height being between 2.50 inches and 4.00 inches;
said base and said at least one arm of said second retaining member each have a width of between 0.50 inch and 1.50 inches, said base has a length being between 0.25 inch and 0.75 inch, and said at least one arm has a height being between 2.00 inches and 3.50 inches; and
said third retaining member has a width being 0.25 inch and 0.75 inch, and a height being between 0.75 inch and 1.5 inches.

5. The clip assembly of claim 4 wherein:
said proximal portion of said third retaining member comprises a lower proximal portion and an upper proximal portion and said distal portion of said third retaining member comprises a lower distal portion and an upper distal portion; and
said lower distal portion is curved outwardly from said lower proximal portion and said upper distal portion is curved inwardly towards said upper proximal portion such that said distal portion is tensioned towards said proximal portion.

6. The clip assembly of claim 5, wherein:
said exterior area of said base of said second retaining member and said exterior area of said at least one arm of said second retaining member define an exterior area of said second retaining member; and
said second retaining member is integral with said first retaining member such that said first upward facing opening is further defined by said exterior region of said second leg of said first retaining member, and said at least one arm comprises a single arm.

7. A clip assembly comprising:
a first retaining member having a first end and a second end, said first and second ends being tensioned towards each other, said first retaining member being configured for removable securement of said clip assembly to a wearable article, said first retaining member having a top part and a pair of legs extending downwardly therefrom, said pair of legs comprising a first leg and a second leg, said top part and said pair of legs defining a downward facing opening configured for removable securement to the wearable article, said top part, said first leg and said second leg each having a width being between 0.50 inch and 1.50 inches, said top part having a length being between 0.25 inch and 0.75 inch, and said first leg and said second leg each having a height being between 2.50 inches and 4.00 inches, said top part said first leg and said second leg each having an exterior region and an interior region;
a second retaining member coupled to said first retaining member configured for removably retaining and carrying a first item while the first item is not in use, said second retaining member comprising a base and at least one arm extending upwardly from said base, said base and said at least one arm each having an interior area and an exterior area, said interior area of said base and said interior area of said at least one arm defining a first upward facing opening configured to removably receive and carry the first item, said base and said at least one arm each having a width being between 0.50 inch and 1.50 inches, said base having a length being between 0.25 inch and 0.75 inch, said at least one arm having a height being between 2.00 inches and 3.50 inches, said exterior area of said base and said exterior area of said at least one arm defining an exterior area of said second retaining member, said second retaining member being integral with said first retaining member such that said first upward facing opening is further defined by said exterior region of said second leg of said first retaining member, said at least one arm further comprising a single arm;
a third retaining member coupled to said second retaining member configured for retaining and carrying a second item while the second item is not in use, said third retaining member further comprising a proximal portion and a distal portion with respect to said second retaining member, said proximal portion and said distal portion each having an interior surface and an exterior surface, said proximal exterior surface of said proximal portion being attached to said second retaining member at said exterior area of said at least one arm thereof, said proximal interior surface of said proximal portion and said distal interior surface of said distal portion defining a second upward facing opening of said third retaining member configured to removably receive and carry the second item, said proximal portion comprising a lower proximal portion and an upper proximal portion and said distal portion comprising a lower distal portion and an upper distal portion, said lower distal portion being curved outwardly from said lower proximal portion and said upper distal portion being curved inwardly towards said upper proximal portion such that said distal portion is tensioned towards said proximal portion, said third retaining member having a width being 0.25 inch and 0.75 inch, said third retaining member having a height being between 0.75 inch and 1.5 inches.
